(19) United States
(12) Patent Application Publication
(10) Pub. No.: US 2011/0089266 A1
(43) Pub. Date: Apr. 21, 2011

(54) FUEL NOZZLE LIP SEALS

(75) Inventors: Lucas John Stoia, Greenville, SC (US); Alberto Negroni, Greenville, SC (US)

(73) Assignee: GENERAL ELECTRIC COMPANY, Schnectady, NY (US)

(21) Appl. No.: 12/580,305

(22) Filed: Oct. 16, 2009

(51) Int. Cl. F02M 61/18

(52) U.S. Cl. 239/533.2

(57) ABSTRACT

The present application provides a fuel nozzle assembly. The fuel nozzle assembly may include a number of concentric tubes and one or more lip seals positioned between a pair of the concentric tubes.

### TECHNICAL FIELD

The present application relates generally to gas turbine engines and more particularly relates to the use of lip seals in combustor nozzles, end covers, and elsewhere.

### BACKGROUND OF THE INVENTION

Gas turbine combustors generally use a number of fuel nozzles positioned. about an end cover. The fuel nozzles and/or end covers deliver various fluids to the combustion system. Generally, the fluid passages of the fuel nozzles may take the form of concentric tubing. Fluid temperature differences, internal combustion chamber air temperature differences, tubing coefficient of thermal expansion differences, and transient gas turbine operations may contribute to axial thermal strains imposed on the concentric tubing. The more recent use of fuels with smaller molecule sizes also requires exceptionally low leakage performance between passages for reliable operation. Additionally, the fuel nozzles and end covers generally are rigidly attached to the turbine structure. For example, the gas turbine rotor can impart significant vibratory loads. As

Piston rings have been employed to accommodate axial thermal growth differences by providing a sliding seal between concentric tubes. The piston rings, however, may have high leakage rates and may not provide adequate support for the internal passages. Bellows also have been employed and provide a hermetic seal between passages. The bellow, however, may be costly, may have durability issues with adjoining welds, and may have limits on how much axial growth can be accommodated.

There is thus a desire therefore for an improved fuel nozzle design that accommodates axial thermal growth, provides ultra low leakage rates, is robust in vibratory environments, and has improved durability. Such a fuel nozzle design should improve overall system and performance and reliability.

### SUMMARY OF THE INVENTION

The present application thus provides a fuel nozzle assembly. The fuel nozzle assembly may include a number of concentric tubes and one or more lip seals positioned between a pair of the concentric tubes.

The present application further provides a fuel nozzle assembly. The fuel nozzle assembly may include a number of concentric tubes with a central fuel passage and a number of secondary passages and one or more lip seals positioned between a pair of the concentric tubes.

The present application further provides a fuel nozzle assembly. The fuel nozzle assembly may include a fuel nozzle end cap assembly and a number of concentric tubes attached to the fuel nozzle end cap assembly. One or more lip seals may be positioned between the fuel nozzle end cap assembly and the concentric tubes.

These and other features of the present application should become apparent to one of ordinary skill in the art upon review of the following detailed description when taken in conjunction with the several drawings and the appended claims.

### BRIEF DESCRIPTION OF THE DRAWINGS

FIG. 1 is a partial cross-sectional view of a gas turbine as may be used herein.

FIG. 2 is a side view of a secondary nozzle assembly as may be used herein.

FIG. 3 is a side cross-sectional view of a portion of a fuel nozzle assembly with lip seals as may be described herein.

FIG. 4 is a side cross-sectional view of a lip seal as may be used with the fuel nozzle assembly described above,

FIG. 5 is a side cross-sectional view of an end cap assembly with the lip seals as may be described herein.

### DETAILED DESCRIPTION

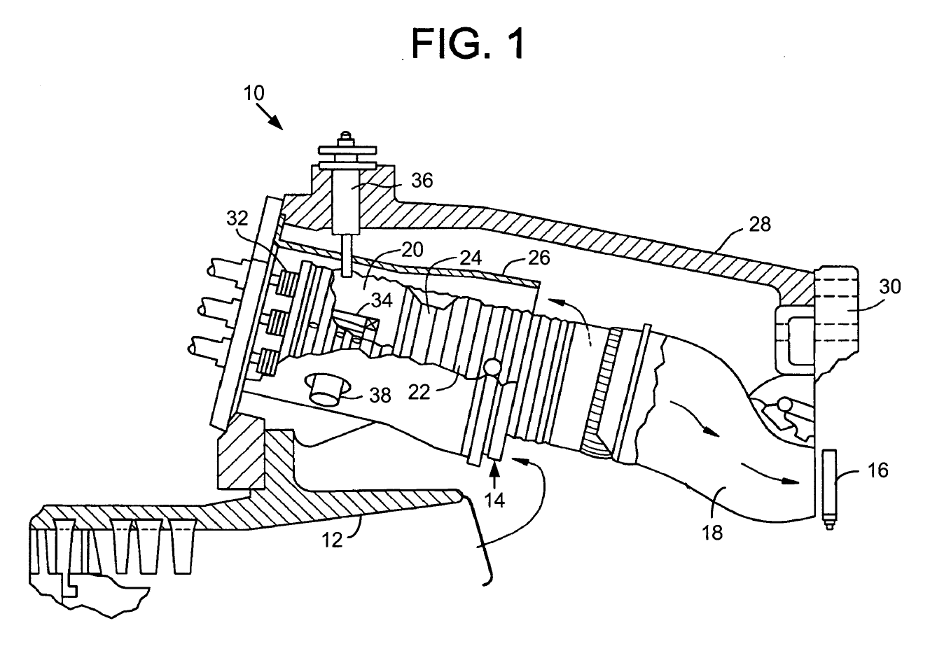

Referring now to the drawings, in which like numbers refer to like elements throughout the several views, FIG. 1 shows portions of a gas turbine engine 10 with a compressor 12 (also partially shown), a combustor 14, and a turbine section 16 represented here by a single blade. Although not specifically shown, the turbine 16 is connected to the compressor 12 along a common axis. The compressor 12 compresses an incoming flow of air and delivers the air to the combustor 14. The combustor 14 mixes the compressed flow of air with a compressed flow of fuel and ignites the mixture. Although only a single combustor 14 is shown, the gas turbine engine 10 may include any number of combustors 14. The combustors 14 may be located in an annular array about the axis of the gas turbine engine 10,

The hot combustion gases are in turn delivered to the turbine 16. The hot combustion gases drive the turbine 16 so as to produce mechanical work. The mechanical work produced by the turbine 16 drives the compressor 12 and generally an external load such as an electrical generator and the like. The gas turbine engine 10 may use natural gas, various types of syngas, and other types of fuels. The gas turbine engine 10 may have other configurations and may use other types of components herein.

A transition duct 18 may connect the outlet end of each combustor 14 with the inlet end of the turbine 16 to deliver the hot combustion gases. Each combustor 14 may include a primary or upstream combustion zone 20 and a secondary or downstream combustion zone 22 generally separated by a throat region 24. The combustor 14 may be surrounded by a combustor flow sleeve 26 no as to channel the compressor discharge airflow to the combustor 14. The combustor 14 further may be surrounded by an outer casing 28 that may be bolted or otherwise attached to a turbine casing 30. The combustor 14 further may include a number of primary nozzles 32 so as to provide fuel to the primary combustion zone 20. The primary nozzles 32 may be arranged in an annular array around a central secondary nozzle 34. Ignition may be achieved in the combustor 14 by means of a sparkplug 36 in conjunction with a number of cross fire tubes 38 (one shown). The secondary nozzle 34 may provide fuel to the secondary combustion zone 22. Other configurations and designs may be used herein.

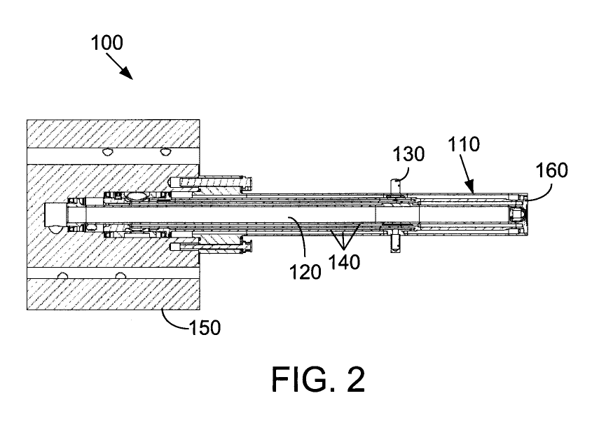

FIG. 2 shows a secondary nozzle assembly 100 as may be described herein. The secondary nozzle assembly 100 may include a number of concentric tubes 110. The concentric tubes 110 may define a number of passages therethrough. The concentric tubes 110 may include a central passage 120. The central passage 120 may be a liquid fuel passage or a purge air passage. Surrounding the central passage 120 may be any number of secondary passages 140. The secondary passages 140 may include pilot, secondary, and tertiary gas passages, water passages, airflow purge passages, and other types of fluid flows.

The concentric tubes 110 may be mounted at one end to a fuel nozzle end cover assembly 150. The concentric tubes 110 may extend to a nozzle tip 160 at the other end. Any number of secondary passages 140 and/or concentric tubes 110 may be used herein. Other configurations and designs may be used herein.

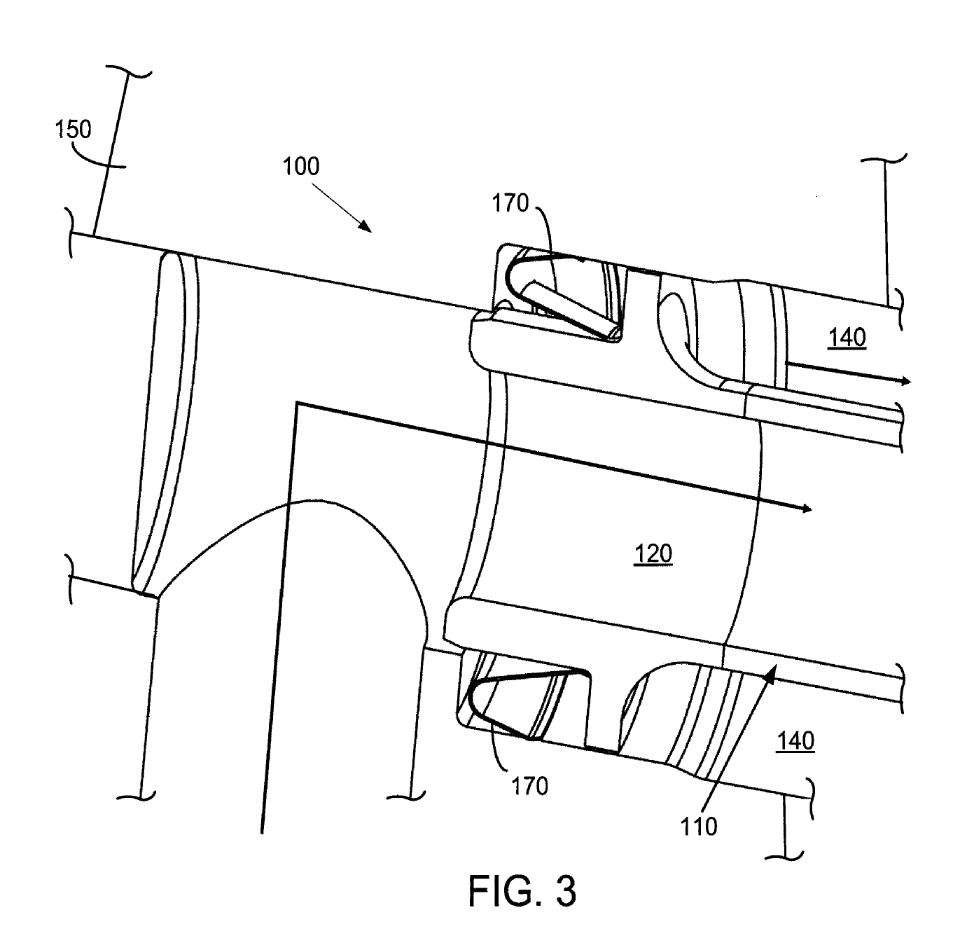

FIG. 3 shows an example of the concentric tubes 110 of the secondary nozzle assembly 100. As is shown, a number of secondary passages 140 surround the central passage 120. Positioned between any pair of the concentric tubes 110 may be a number of lip seals 170. The lip seal 170 is a form of a radial seal that reduces fuel leakage therethrough. The lip seal 170 also may be positioned between the concentric tubes 110 and the fuel nozzle end cover assembly 150.

The lip seals 170 are typically applied to rotating shafts and can handle extremely high operating pressures. Generally described, the lip seal 170 seals by seating on a shaft that compresses the inside diameter and seats in a bore that compresses the outside diameter. In a typical rotating shaft application, the inside diameter would be considered the dynamic side of the seal as the shaft will rotate relative to the stationary lip seal. The seal design relies on compression to provide a normal force on the inside and outside sealing surfaces. The lip seal 170 may be compressed by an assembly on the shaft and inserted into a bore with appropriate tooling,

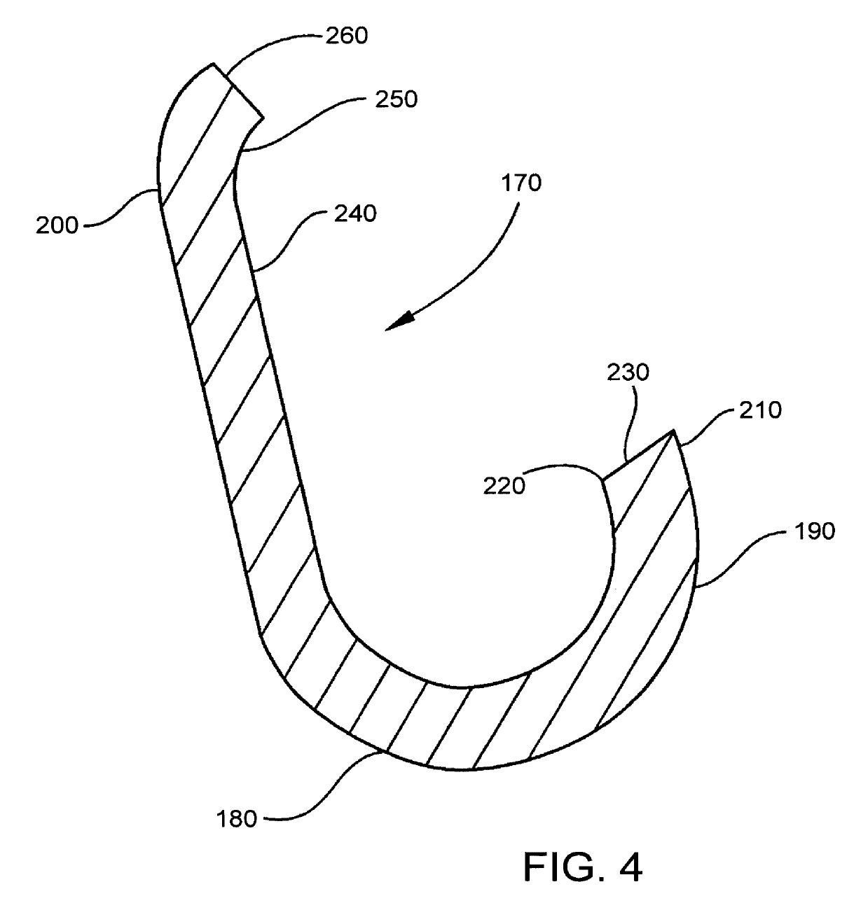

FIG. 4 shows a side view of an example of the lip seal 170. The lip seal 170 may include an arcuate portion 180, an outer sealing line 190, and an inner sealing line 200. The lip seal 170 may include an inward curl 210 at one end of the arcuate portion 180 so as to form a return 220 at a first edge 230. The lip seal 170 also may include an inwardly tapering frustro-conical portion or longitudinally extended portion 240 that terminates in an outward curved portion 250 to the second opposed edge 260. The function of the return 220 is to provide stiffening and a lead that facilitates the smooth insertion of the seal 170 into an internal cavity. Other configurations and designs may be used herein. The lip seal 170 may be made out of nickel super alloys, nickel cobalt alloys, and similar materials.

In the present application, the lip seals 170 allow for thermal growth in that the lip seal 170 allows for axial sliding along the inside diameter or inner curl 210 while maintaining a seat The lip seal 170 is basically a metallic radial spring. Because the lip seal 170 is a full circumferential spring seal, the lip seal 170 also increases the natural frequencies of the nozzle components away from excitation sources. The frictional interface of the seal 170 may increase the damping characteristics. The improved sealing also reduces pilot flow variations in ultra low emission combustors, Additionally, the lip seals 170 may allow for higher concentrations of H₂ and similar highly reactive, small molecule fuels with an acceptable leakage for greater fuel flexibility.

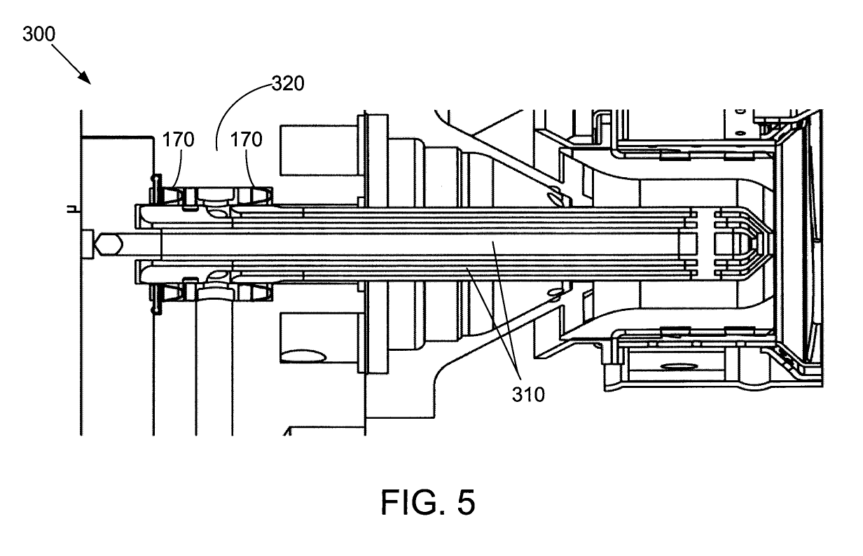

FIG. 5 shows a further nozzle 300. In this example, the nozzle 100 includes a number of concentric tubes 310 extending from an end cap assembly 320. A number of the lip seals 170 may be positioned within the end cap assembly 320 about the concentric tubes 310. The lip seals 170 function as above so as to accommodate axial thermal growth and otherwise. The lip seals 170 may be positioned elsewhere about the nozzle 100 and otherwise.

The use of the lip seals 170 about the concentric tubes 110, 310 and the fuel nozzle end cover assembly 150, 320 thus provides for axial thermal growth, reduced leakage, and improved natural frequency vibration damping. Moreover, reduced. flow variation may lead to improved emissions performance. Improved sealing may allow for additional tuning space to achieve even lower emissions performance.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A fuel nozzle assembly, comprising:
a plurality of concentric tubes; and
one or more lip seals positioned between a pair of the plurality of concentric tubes.

2. The fuel nozzle assembly of claim 1, further comprising a fuel nozzle end cover assembly and wherein one or more of the lip seals are positioned between the fuel nozzle end cover assembly and one of the plurality of concentric tubes.

3. The fuel nozzle assembly of claim 1, wherein the plurality of concentric tubes comprises a central passage and a plurality of secondary passages.

4. The fuel nozzle assembly of claim 3, wherein the central passage comprises a liquid fuel passage.

5. The fuel nozzle assembly of claim 3, wherein the plurality of secondary passages comprises pilot gas passages, secondary gas passages, tertiary gas passages, water purge passages, and/or airflow passages.

6. The fuel nozzle assembly of claim 3, wherein the pair of the plurality of concentric tubes comprises the central passage and one of the plurality of secondary passages.

7. The fuel nozzle assembly of claim 3, wherein the pair of the plurality of concentric tubes comprises a pair of the plurality of secondary passages.

8. The fuel nozzle assembly of claim 1, wherein the one or more lip seals comprise an inward curl.

9. The fuel nozzle assembly of claim 1, wherein the one or more lip seals comprise an inwardly tapering frustro-conical portion.

10. The fuel nozzle assembly of claim 1, wherein the one or more lip seals comprise a return.

11. The fuel nozzle assembly of claim 1, wherein the one or more lip seals comprise a radial seal.

12. The fuel nozzle assembly of claim 1, wherein the one or more lip seals comprise nickel super alloys or nickel cobalt alloys.

13. A fuel nozzle assembly, comprising:
a plurality of concentric tubes;
the plurality of concentric tubes comprising a central fuel passage and a plurality of secondary passages; and
one or more lip seals positioned between a pair of the plurality of concentric tubes.

14. The fuel nozzle assembly of claim 13, wherein the plurality of secondary passages comprises pilot gas passages, secondary gas passages, tertiary gas passages, water purge passages, and/or airflow passages.

15. The fuel nozzle assembly of claim 13, wherein the one or more lip seals are positioned between the central fuel passage and one of the plurality of secondary passages.

16. The fuel nozzle assembly of claim 13, wherein the one or more lip seals are positioned between a pair of the plurality of secondary passages.

17. The fuel nozzle assembly of claim 13, further comprising a fuel nozzle end cover assembly and wherein one or more of the lip seals are positioned between the fuel nozzle end cover assembly and one of the plurality of concentric tubes.

18. The fuel nozzle assembly of claim 13, wherein the one or more lip seals comprise an inward curl.

19. The fuel nozzle assembly of claim 13, wherein the one or more lip seals comprise an inwardly tapering frustro-conical portion.

20. A fuel nozzle assembly, comprising:
a fuel nozzle end cap assembly;
a plurality of concentric tubes attached to the fuel nozzle end cap assembly; and
one or more lip seals positioned between the fuel nozzle end cap assembly and the plurality of concentric tubes.
